(19) United States
(12) Patent Application Publication
(10) Pub. No.: US 2014/0118377 A1
(43) Pub. Date: May 1, 2014

(54) DISPLAY DRIVER CIRCUIT, DISPLAY DEVICE COMPRISING SAME, AND METHOD OF OPERATING SAME

(71) Applicant: SAMSUNG ELECTRONICS CO., LTD., Suwon-si (KR)

(72) Inventors: JONG-KON BAE, SEOUL (KR); YANG-HYO KIM, HWASEONG-SI (KR); WON-SIK KANG, SEOUL (KR); DO-KYUNG KIM, YONGIN-SI (KR); JAE-HYUCK WOO, OSAN-SI (KR)

(73) Assignee: SAMSUNG ELECTRONICS CO., LTD., Suwon-si (KR)

(21) Appl. No.: 14/056,996

(22) Filed: Oct. 18, 2013

(30) Foreign Application Priority Data
Oct. 26, 2012 (KR) 10-2012-0119792

(51) Int. Cl. G09G 5/395

(52) U.S. Cl. CPC G09G 5/395
USPC 345/545

(57) ABSTRACT

A display driver circuit comprises a frame memory comprising m main rows (m>1) and n dummy rows (0<n<m) corresponding to m horizontal display lines of a panel and configured to store received first frame data in m rows among the m main rows and the n dummy rows, and a memory control unit configured to control write and scan operations of the frame memory such that the first frame data is written from a write start row selected from among the m main rows and the n dummy rows.

### CROSS-REFERENCE TO RELATED APPLICATIONS

This application claims priority under 35 U.S.C. §119 to Korean Patent Application No. 10-2012-0119792 filed on Oct. 26, 2012, the subject matter of which is hereby incorporated by reference.

### BACKGROUND OF THE INVENTION

The inventive concept relates generally to electronic display technologies. More particularly, certain embodiments of the inventive concept relate to a display driver circuit that operates asynchronously with an external device providing frame data.

A display device typically comprises a display driver circuit and a display panel. The display driver circuit drives the display panel according to frame data received from a host. The display driver circuit typically comprises a frame memory in order to reduce the processing load and current consumption of the host.

During typical operation, the display driver circuit receives frame data at a certain time, stores the received frame data in the frame memory, and periodically scans the frame memory for the frame data to drive the display panel. During operation, however, a screen tearing effect may occur in which different images are displayed in an upper portion and a lower portion of one screen. This screen tearing effect is generally caused by a difference between a speed at which the received frame data is written to the frame memory and a speed at which the frame data to be displayed is scanned in the frame memory. To prevent the screen tearing effect, the host may transmit the frame data in response to a synchronization signal transmitted from the display driver circuit. In this case, however, the host needs to detect the transmission of a synchronization signal, which tends to increase the processing load of the host.

### SUMMARY OF THE INVENTION

In one embodiment of the inventive concept, a display driver circuit comprises a frame memory comprising m main rows (m>1) and n dummy rows (0<n<m) corresponding to m horizontal display lines of a panel and configured to store received first frame data in m rows among the m main rows and the n dummy rows, and a memory control unit configured to control write and scan operations of the frame memory such that the first frame data is written from a write start row selected from among the m main rows and the n dummy rows.

In another embodiment of the inventive concept, a display device comprises a panel comprising m (m>1) horizontal display lines, and a driver circuit comprising a memory unit comprising k row addresses (k>m), and a memory control unit configured to select m write row addresses where a first frame data received from a host is to be written and m scan row addresses where a second frame data to be displayed on the panel is to be scanned, and to provide selected addresses to the memory unit.

In another embodiment of the inventive concept, a method of operating a display driver circuit comprises receiving a first frame of image data, selecting a write start row from among m main rows (m>1) and n dummy rows (0<n<m) of a frame memory, storing the first frame in m rows of the frame memory, beginning at the selected write start row, and scanning the frame memory, starting at the write start row.

These and other embodiments of the inventive concept can potentially improve performance of a display system by allowing asynchronous operation of a display driving circuit with respect to a host, thereby reducing a processing load of a host.

### BRIEF DESCRIPTION OF THE DRAWINGS

The drawings illustrate selected embodiments of the inventive concept. In the drawings, like reference numbers indicate like features.

FIG. 1 is a block diagram illustrating a display device according to an embodiment of the inventive concept.

FIG. 2A is a conceptual diagram illustrating one example of a screen tearing effect.

FIG. 2B is a conceptual diagram illustrating another example of a screen tearing effect.

FIG. 3 is a block diagram illustrating an example of a drive control unit and an interface unit in the display device of FIG. 1.

FIG. 4 illustrates an example of a frame memory in the display device of FIG. 1.

FIG. 5A is a timing diagram illustrating an example of a write operation and a scan operation of the frame memory of FIG. 1.

FIG. 5B is a frame memory diagram for the example operations illustrated in FIG. 5A.

FIG. 6A is a timing diagram illustrating another example of a write operation and a scan operation of the frame memory of FIG. 1.

FIG. 6B is a frame memory diagram for the example operations illustrated in FIG. 6A.

FIG. 7A is a timing diagram illustrating yet another example of a write operation and a scan operation of the frame memory of FIG. 1.

FIG. 7B is a frame memory diagram for the example operations illustrated in FIG. 7A.

FIG. 8A is a timing diagram illustrating yet another example of a write operation and a scan operation of the frame memory of FIG. 1.

FIG. 8B is a frame memory diagram for the example operations illustrated in FIG. 8A.

FIG. 9 is a timing diagram illustrating an example implementation of a panel self refresh (PSR) function in the display device of FIG. 1.

FIG. 10 is a block diagram illustrating another example of the drive control unit of FIG. 1.

FIG. 11 is an exploded perspective view illustrating a display module according to an embodiment of the inventive concept.

FIG. 12 is a block diagram illustrating a display system according to an embodiment of the inventive concept.

FIG. 13 illustrates various examples of electronic products comprising a display device according to an embodiment of the inventive concept.

### DETAILED DESCRIPTION

Selected embodiments of the inventive concept are described below with reference to the accompanying drawings. These embodiments are presented as teaching examples and should not be construed to limit the scope of the inventive concept.

In the description that follows, the terms used to describe various embodiments are not to limit the scope of the inventive concept. Expressions in singular form (e.g., “a”, “the”) are intended to encompass the plural form as well, unless otherwise specified. Terms such as “include” or “comprise” are to be construed in open-ended fashion, unless otherwise specified. Terms used herein, including technical or scientific terms, have the same meanings as those generally understood by those of ordinary skill in the art. Terms such as those defined in generally used dictionaries are to be interpreted in their proper context and are not to be construed in an overly idealized or formal manner.

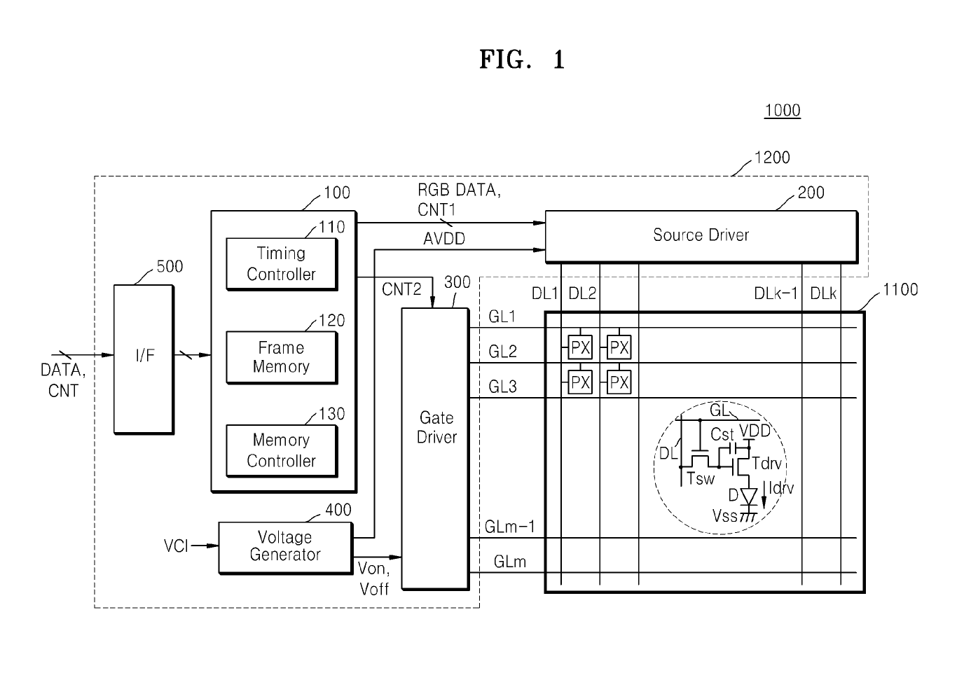

FIG. 1 is a block diagram illustrating a display device 1000 according to an embodiment of the inventive concept.

Referring to FIG. 1, display device 1000 comprises a panel 1100 for displaying an image and a display driver circuit 1200 for driving panel 1100 based on received image data DATA and a control signal CNT.

Display device 1000 may take various alternative forms. For example, FIG. 1 illustrates display device 1000 as an organic light emitting diode (OLED) display. Alternatively, it may comprise a liquid crystal display (LCD), a plasma display panel (PDP) display, an electrochromic display (ECD), a digital mirror device (DMD), an actuated mirror device (AMD), a grating light value (GLV), or an electro luminescent display (ELD). For explanation purposes, it will be assumed that display device 1000 is assumed to be an OLED.

Panel 1100 comprises a plurality of gate lines GL1-GLm to transfer a scanning signal in a column direction, a plurality of data lines DL1-DLk arranged in a direction crossing the gate lines GL1-GLm to transfer a data signal in a row direction, and a plurality of pixels PX arranged where the gate lines GL1-GLm and the data lines DL1-DLk cross each other. Where gate lines GL1-GLm are sequentially selected, a gradation voltage Vg is applied to the pixel PX connected to a selected gate line, through the data lines DL1-DLk.

Each pixel PX comprises a switching transistor Tsw, a driver transistor Tdrv, a storage capacitor Cst, and an organic light emitting diode D. A gate line GL and a data line DL are respectively connected to a gate electrode and a source electrode of switching transistor Tsw. A drain electrode of switching transistor Tsw and a power voltage VDD are respectively connected to a gate electrode and a source electrode of driver transistor Tdrv. A drain electrode of driver transistor Tdry is connected to an anode of the organic light emitting diode D. In the above pixel structure, where gate line GL is selected, switching transistor Tsw is turned on and thus gradation voltage Vg provided through data line DL is applied to the gate electrode of driver transistor Tdrv. A display operation is performed as a drive current Idrv, which is generated according to a difference between the power voltage VDD and gradation voltage Vg, flows through the organic light emitting diode D.

Display driver circuit 1200 comprises a drive control unit 100, a source driver 200, and a gate driver 300. Also, display driver circuit 1200 may further include a voltage generation unit 400 and an interface unit 500.

Drive control unit 100 receives image data DATA and control signal CNT from an external device, for example, a host of a system where display device 1000 is mounted, and provides a control signal CNT1 and pixel data RGB DATA to source driver 200, and provides a control signal CNT2 to the gate driver 300. Drive control unit 100 comprises a timing controller 110, a frame memory 120, and a memory controller 130. Timing controller 110 generates control signals CNT1 and CNT2 including timing signals for controlling source and gate drivers 200 and 300.

Frame memory 120 temporarily stores image data DATA of one frame to be displayed on panel 1100, and it outputs the stored image data DATA to be displayed on panel 1100. Frame memory 120 may be referred to a graphic RAM, and a volatile memory such as a static random access memory (SRAM) may be used as frame memory 120. However, the inventive concept is not limited thereto and various types of memories may be used as frame memory 120. Memory controller 130 controls various operations of frame memory 120, such as addressing and timing used to perform write and scan operations in frame memory 120.

Source driver 200 converts pixel data RGB DATA that is digital data received from drive control unit 100 to gradation voltage Vg and outputs gradation voltage Vg to data lines DL1-DLk of panel 1100. Gate driver 300 sequentially scans gate lines GL1-GLm of panel 1100. Gate driver 300 applies a gate-on voltage Von to a selected gate line to activate the selected gate line. Source driver 200 outputs gradation voltage Vg corresponding to pixels PX connected to the activated gate line. Accordingly, panel 1100 may display an image in units of horizontal lines, that is, row by row. Although gate driver 300 is illustrated to be provided in display driver circuit 1200 in display device 1000, the inventive concept is not limited thereto. As an alternative, for instance, gate driver 300 may be directly provided on panel 1100 formed of a low temperature polysilicon (LTPS).

Voltage generation unit 400 receives an external power voltage VCI and generates voltages AVDD, Von, and Voff used by source and gate drivers 200 and 300.

Interface unit 500 receives image data DATA and control signal CNT that are provided in parallel or in series from the external device, and it provides the received data and signal to drive control unit 100. Image data DATA and control signal CNT are typically transmitted from the host of a system including display device 1000. Interface unit 500 receives image data DATA and control signal CNT according to an interface type corresponding to a transmission method of the host. As examples, the interface method used by interface unit 500 may be one of an RGB interface method, a CPU interface method, a service provider interface SPI method, a mobile display digital interface (MDDI) method, and a mobile industry processor interface (MIPI) method.

In display device 1000, frame memory 120 comprises rows numbering more than the number of horizontal lines of panel 1100. Memory controller 130 writes the received image data DATA to some of the rows of frame memory 120 or scans the stored image data DATA. In other words, data write and scan operations are selectively performed for some of rows of frame memory 120. Accordingly, even though image data DATA is provided from the host at random timing, a screen tearing effect may be prevented from being generated by appropriately controlling the positions of a row where writing is performed and a row where scanning is performed.

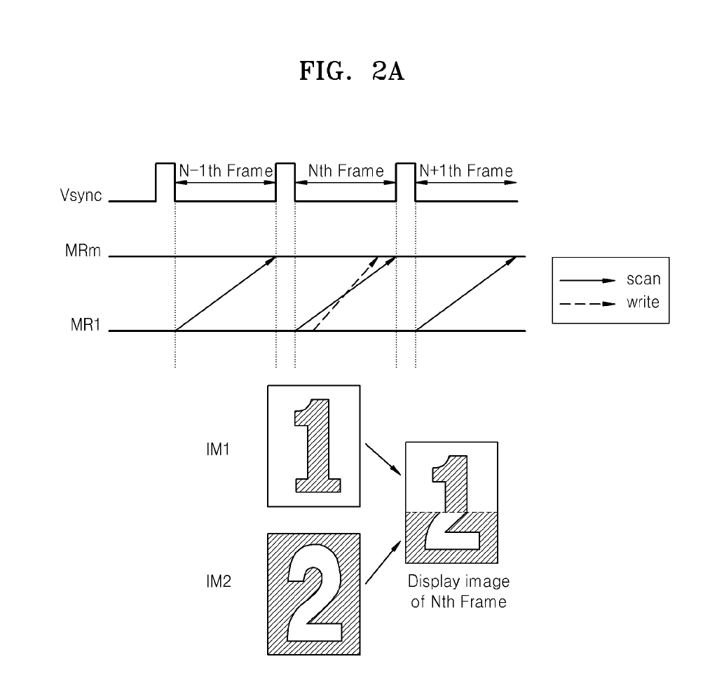

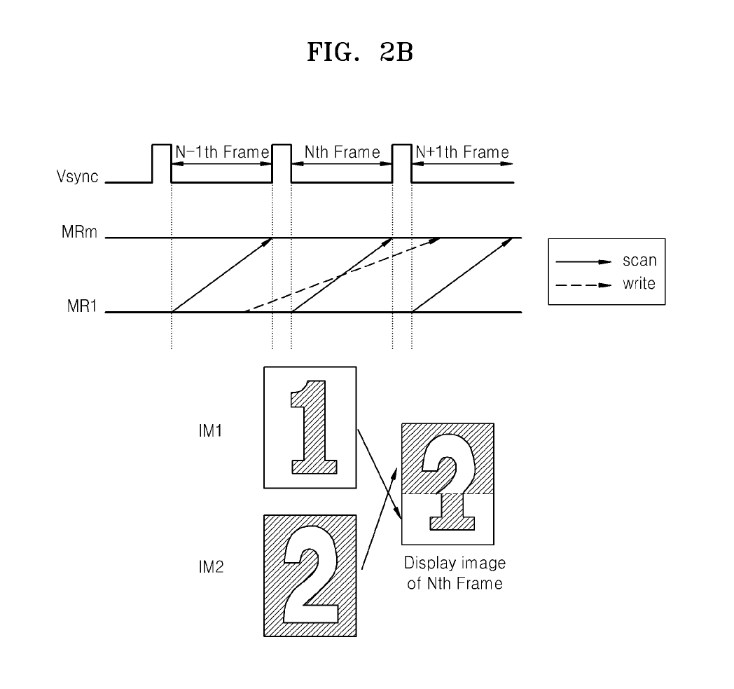

FIGS. 2A and 2B illustrate examples of a screen tearing effect. In particular, FIG. 2A illustrates an example in which a scan speed is faster than a write speed, and FIG. 2B illustrates an example in which a scan speed is slower than a write speed so that a screen tearing effect occurs.

Referring to FIGS. 2A and 2B, a scan operation of a frame memory for display is performed for each section where a vertical sync signal Vsync is at a low level. Where a display panel comprises m horizontal lines, a scan operation is performed from a first memory row MR1 to an m-th memory row MRm. Where first memory row MR1 to m-th memory row MRm of the frame memory are sequentially scanned and thus image data stored at first memory row MR1 to m-th memory row MRm of the frame memory are displayed on panel 1100 of FIG. 1, displaying of one frame is completed. Where frame data is received from the external device while the scan operation of the frame memory is performed, a write operation is performed concurrently with scanning However, the scan speed and the write speed are not always the same. As illustrated in FIGS. 2A and 2B, the write speed may be faster or slower than the scan speed. A screen tearing effect may occur due to a difference between the write speed and the scan speed.

Referring to FIG. 2A, in an N-th frame section, in the middle of displaying first image data IM1 by scanning the frame memory, second image data IM2 is received and writing of second image data IM2 to the frame memory begins. Where a write speed is faster than a scan speed, the writing of second image data IM2 is completed before the scanning of first image data Iml is completed. Then, the frame memory that is already updated with second image data IM2 is scanned at a portion of time in the N-th frame section. Thus, as illustrated in FIG. 2A, first image data IM1 is displayed in an upper portion of a screen and second image data IM2 is displayed in a lower portion of the screen, and thus a screen tearing effect occurs.

Referring to FIG. 2B, in a (N−1)-th frame section, while first image data IM1 stored in the frame memory is scanned, the received second image data IM2 may be written to the frame memory at the same time. The Scanning of second image data IM2 may be begun in the N-th frame section. However, because the write speed is slower than the scan speed, the writing of second image data IM2 may not be completed in the N-th frame section. As a result, as illustrated in FIG. 2B, second image data IM2 is displayed in the upper portion of the screen and first image data IM1 that is displayed in the previous frame is displayed again in the lower portion of the screen, and thus a screen tearing effect occurs.

To prevent the screen tearing effect, a conventional display device operates in synchronization with the host. Where a sync signal indicating a display state is transmitted to the host, the host monitors the sync signal and transmits image data at an assigned time. However, there is a processing load on the host to monitor the sync signal and where image data is not transmitted as soon as generation of a sync signal is detected, an image quality degradation phenomenon such as flicker may occur.

Display device 1000, however, controls a write address and a scan address of frame memory 120, so it can display an image without the screen tearing effect while operating asynchronously with the host. Because there is no need to generate or monitor a sync signal in transmission of image data DATA between the host and display device 1000, a processing load on the system can be reduced and the system can be operated using less power.

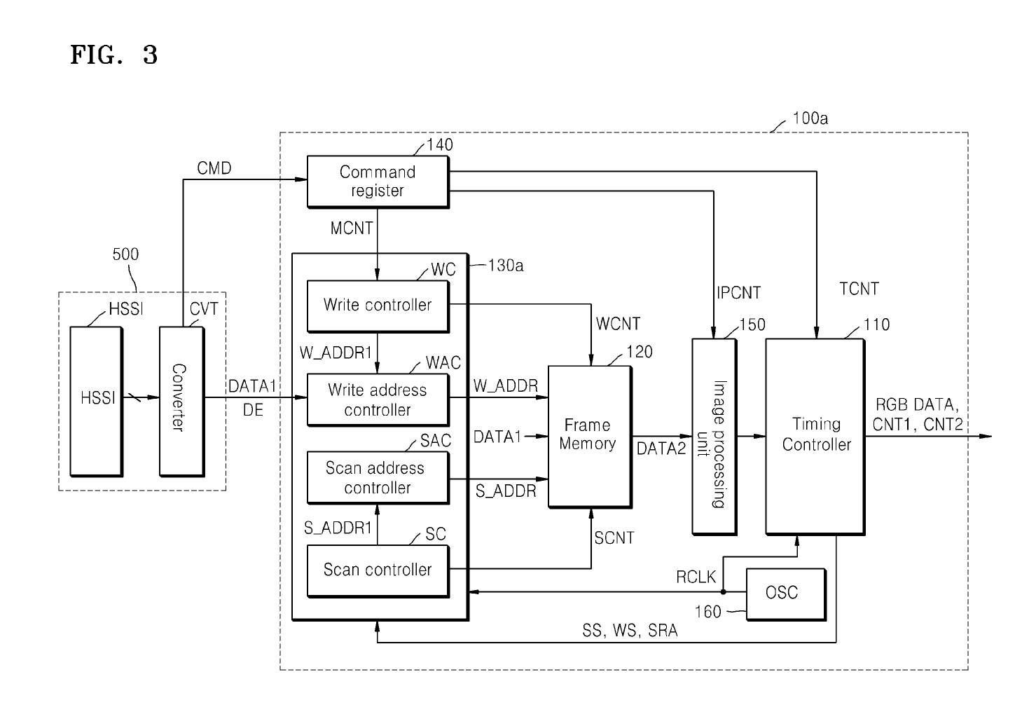

FIG. 3 is a block diagram illustrating an example of drive control unit 100 and interface unit 500 of FIG. 1.

Referring to FIG. 3, interface unit 500 comprises an interface unit HSSI and a converter CVT. A drive control unit 100a comprises a timing controller 110, a frame memory 120, and a memory controller 130a. Drive control unit 100a further comprises a command register 140, an image processing unit 150, and an oscillator 160.

Interface unit HSSI adopts a high speed serial interface method. For example, interface unit HSSI may adopt a mobile industry processor interface (MIPI) and may transmit/receive data at high speed through a plurality of input/output terminals. However, the inventive concept is not limited thereto and a variety of types of interfaces may be used. Image data DATA and control signal CNT received through the interface unit HSSI are applied to converter CVT. Because image data DATA and control signal CNT are received altogether regardless of a type of data, converter CVT classifies the received data into a command signal CMD, image data DATA1 (hereinafter, the “frame data”) of one frame to be stored in frame memory 120, and a data enable signal DE, and outputs the classified data and signals to corresponding circuit blocks.

Command register 140 stores command signal CMD transmitted by converter CVT. Command signal CMD is a value to appropriately control circuits 130a, 150, and 110 according to a display drive environment and a variety of values may be set according to a resolution of a panel and an image signal processing method. Command register 140 generates signals MCNT, WCNT, IPCNT, and TCNT to control memory controller 130a, image processing unit 150, and timing controller 110 based on command signal CMD, and provides the generated signals to the above circuits.

Image processing unit 150 converts image data DATA2 received from frame memory 120 to have a value appropriate for an environment of panel 1100 of FIG. 1 based on control signal IPCNT, and transmits the converted data to timing controller 110.

Oscillator 160 generates a reference clock RCLK and provides the generated reference clock RCLK to timing controller 110 and memory controller 130a.

As described above with reference to FIG. 1, frame memory 120 comprises a larger number of rows than the number of the m horizontal lines of panel 1100 that are received from the external device, and stores the frame data DATA1 in some of the rows, for example, in m rows.

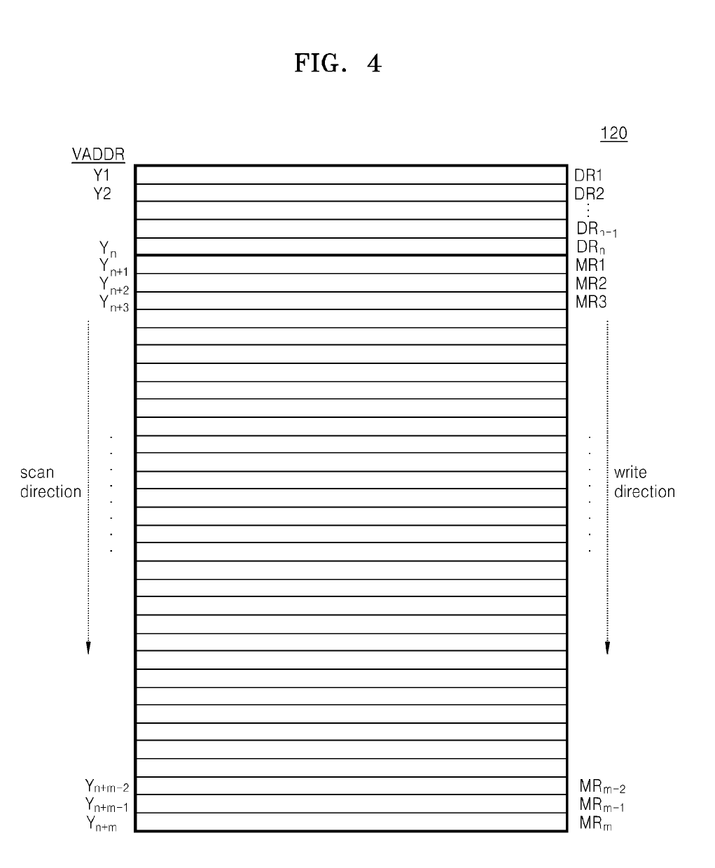

FIG. 4 illustrates an example of frame memory 120 of FIG. 1.

Referring to FIG. 4, frame memory 120 comprises n dummy rows DR1-DRn and m main rows MR1-MRm. The number of dummy rows is less than the number of main rows. One of row addresses Y1-Yn+m is assigned to each of dummy rows DR1-DRn and main rows MR1-MRm. Although dummy rows DR1-DRn and main rows MR1-MRm are divided for convenience of explanation, the dummy rows and the main rows are not necessarily physically divided. The dummy rows and the main rows may be changed according to a state in which the frame data is stored. The m rows where effective frame data is stored may be determined to be the main rows.

Main rows MR1-MRm correspond to the m horizontal lines of panel 1100. Pixel data corresponding to one horizontal line of panel 1100 are stored in one row. Because data of one frame comprises data corresponding to the m horizontal lines, the frame data is stored in m rows among the (m+n) rows. Accordingly, the frame data is selectively written to the m rows among the (m+n) rows, and then scanned. The m rows sequentially arranged in a scan direction and a write direction as illustrated in FIG. 4 are scanned or written.

Referring again to FIG. 3, memory controller 130a provides a write address and a scan address to frame memory 120, and controls timing to perform a write operation and a scan operation. Memory controller 130a comprises a write controller WC, a write address controller WAC, a scan controller SC, and a scan address controller SAC.

Write controller WC generates a write control signal WCNT to control the write operation of frame memory 120 and a first write address W_ADDR1. Write control signal WCNT comprises information regarding the timing at which the write operation is performed on frame memory 120 or a write clock signal, and it is typically generated based on the received data enable signal DE and memory control signal MCNT. Data enable signal DE is a signal indicating that received data is valid data. Write controller WC generates write control signal WCNT to write only valid image data to frame memory 120 based on data enable signal DE. First write address W_ADDR1 is an address indicating a position where a next write is to be performed based on a position where a previous write is performed.

Write address controller WAC generates a write address W_ADDR where actual writing is to be performed based on first write address W_ADDR1. For example, first write address W_ADDR1 may be an address corresponding to only main rows MR1-MRm of frame memory 120. However, actual writing may be performed on the selected M rows of main rows MR1-MRm and dummy rows DR1-DRn. Thus, write address controller WAC generates write address W_ADDR where actual writing is to be performed based on first write address W_ADDR1 and provides the generated write address to frame memory 120.

Scan controller SC generates a scan control signal SCNT to control a scan operation of frame memory 120 and a first scan address S_ADDR1. Scan control signal SCNT comprises information in regard to timing at which the scan operation is performed on frame memory 120 or a scan clock signal. First scan address S_ADDR1 is an address indicating a position where a next scan is to be performed based on a position where a previous scan is performed.

Scan address controller SAC generates a scan address S_ADDR where actual scanning is to be performed based on first scan address S_ADDR1. For example, first scan address S_ADDR1 may be an address corresponding to only main rows MR1-MRm of frame memory 120. However, as described above, the actual frame data may be written to dummy rows DR1-DRn to be stored therein. The actual scanning may be performed on the rows where the frame data is stored. Thus, scan address controller SAC generates address S_ADDR where the actual scanning is to be performed based on first scan address S_ADDR1 and provides the generated scan address to frame memory 120.

Timing controller 110 detects a write speed WS and a scan speed SS of frame memory 120 based on reference clock RCLK generated by oscillator 160. Also, timing controller 110 determines a scan row address SRA which is a row that is scanned where first frame data is received. Timing controller 110 provides the detected write speed WS, scan speed SS, and scan row address SRA of frame memory 120 to memory controller 130a. Also, timing controller 110 may provide a control signal to adjust the scan speed SS to be identical to the write speed WS based on the detected write speed WS, to memory controller 130a.

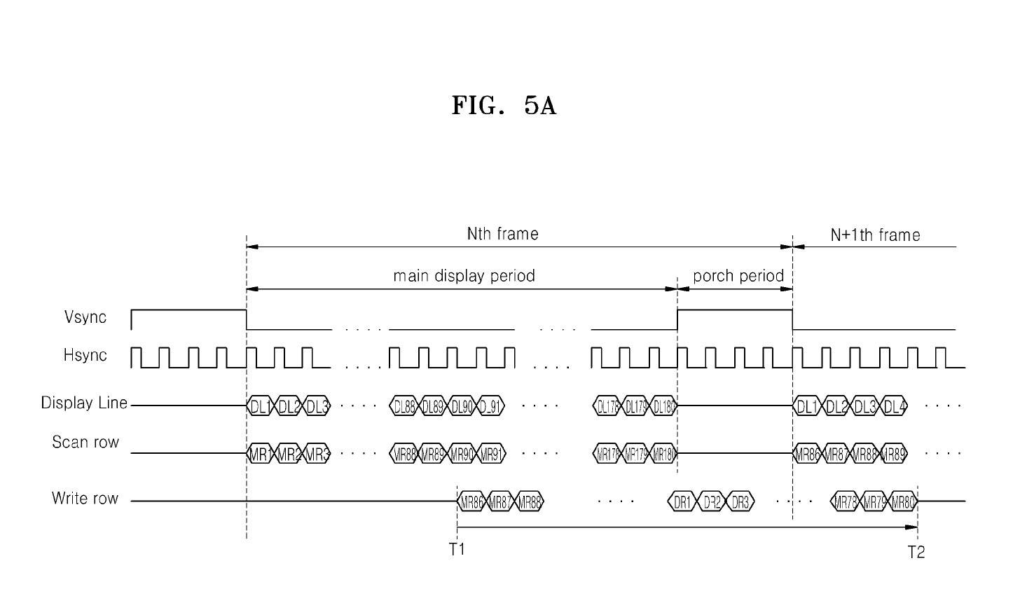

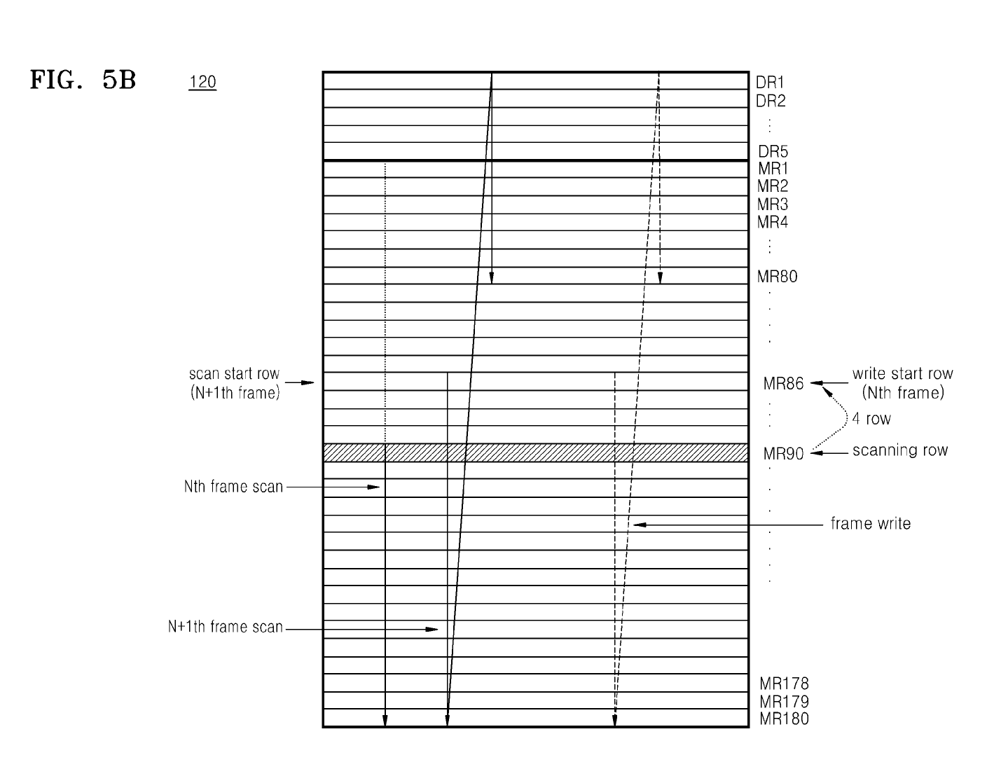

Write address controller WAC and scan address controller SAC may generate write address W_ADDR and the scan address S_ADDR based on the write speed WS and the scan speed SS of the frame memory 120 and the scan row address SRA, provided by timing controller 110, respectively. Next, the write and scan operations of frame memory 120 will be described in detail with reference to FIGS. 5A to 8B. For convenience of explanation, it is assumed that frame memory 120 of FIG. 1 comprises five (5) dummy rows and one hundred and eighty (180) main rows, although these numbers may differ in alternative embodiments.

FIGS. 5A and 5B are a timing diagram and a frame memory diagram, respectively, for explaining an example of write and scan methods of frame memory 120.

Referring to FIG. 5A, an image is displayed on panel 1100 of FIG. 1 based on a vertical sync signal Vsync and a horizontal sync signal Hsync. One frame of the display section is set from a falling edge to a next falling edge of vertical sync signal Vsync.

A section where vertical sync signal Vsync is at a low level is a main display period, in which gradation voltages corresponding to pixel data are applied to panel 1100 of FIG. 1 and thus an image is displayed. A section where vertical sync signal Vsync is a high level is a porch period, in which although actual displaying is not performed, the image displayed in the main display period is maintained and display driver circuit 1200 of FIG. 1 performs an operation for displaying the next frame. In the main display period, the rows of frame memory 120 of FIG. 1 are scanned in response to each clock of the horizontal sync signal Hsync, and the pixel data output from frame memory 120 is displayed on the horizontal lines of panel 1100.

As illustrated in FIG. 5A, where frame data is received from the external device in an N-th frame display period, the received frame data is written to the frame memory (hereinafter, “first frame data”). Because the N-th frame is displayed, a scan operation is performed concurrently with a write operation. A row (hereinafter, “write start row”) where writing starts and a row (hereinafter, “scan start row”) where scanning starts in a next (N+1)-th frame display period are selected based on the write speed, the scan speed, and the position of a main row (hereinafter, “scanning row”) that is scanned at a time T1 where the first frame data starts to be received. Then, the frame data are sequentially written to the m rows consecutively from the selected row in units of lines.

The row located a predetermined number of rows before the scanning row is selected as the write start row. Whether to select a row located a certain number of rows before the scanning row as the write start row and the scan start row may be determined based on the write speed and the scan speed in a range in which a screen tearing effect does not occur.

Referring to FIG. 5B, where the scanning row is the 90^{th} main row MR90, the 86^{th} main row MR86 that is located four (4) rows before the 90^{th} main row MR90 is selected as the write start row and the scan start row. If the scanning row is the 86^{th} main row MR86, the 82^{nd} main row MR82 that is located four (4) rows before the 86^{th} main row MR86 may be selected as the write start row and the scan start row. The first frame data is written to one hundred and eighty (180) rows consecutively in units of horizontal lines. Therefore, after being written consecutively from the selected write start row MR86 to a final main row MR180, the first frame data is consecutively written from first dummy row DR1 to the 80^{th} main row MR80. Also, the frame data to be displayed at the (N+1)-th frame (hereinafter, “second frame data”) is sequentially scanned and output from the 86^{th} main row MR86 to the final main row MR180 and then from first dummy row DR1 to the 80^{th} main row MR80 of frame memory 120.

Referring again to FIG. 5A, where the write start row is determined, the first frame data starts to be written from the write start row in units of lines. Because the 86^{th} main row MR86 is selected as the write start row, writing starts from the 86^{th} main row MR86 until final main row MR180 and then from first dummy row DR1 to the 80^{th} main row MR80 so that writing is performed on a total of 180 rows. The writing of the first data may be continuously performed until a certain time T2 in the (N+1)-th frame display period. Because the 86^{th} main row MR86 is selected as the scan start row, where the (N+1)-th frame display period starts, the 86^{th} main row MR86 is scanned so that the first horizontal line is displayed. The second frame data output as the 180 rows are sequentially scanned from the 86^{th} main row MR86 to the 80^{th} main row MR80 is displayed on every horizontal line on panel 1100.

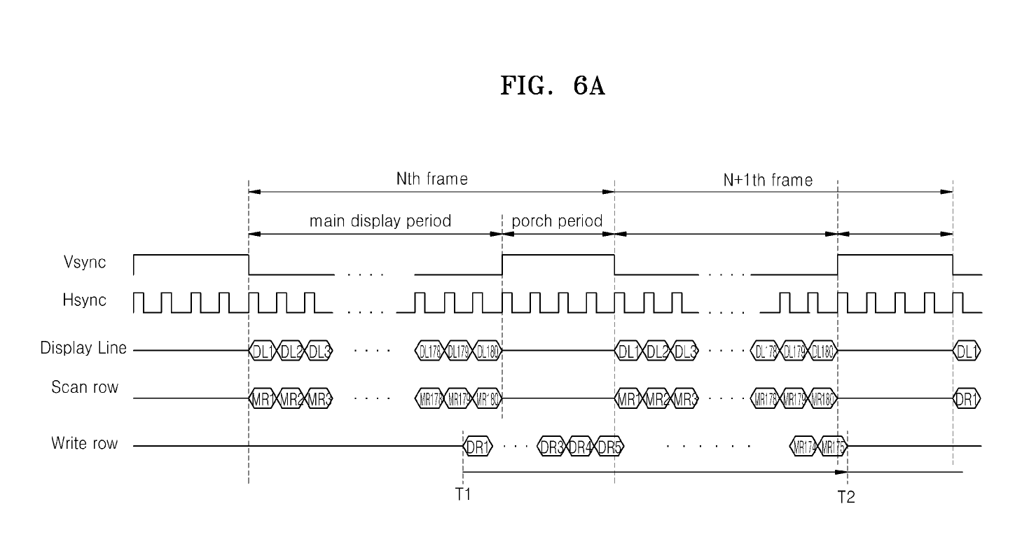

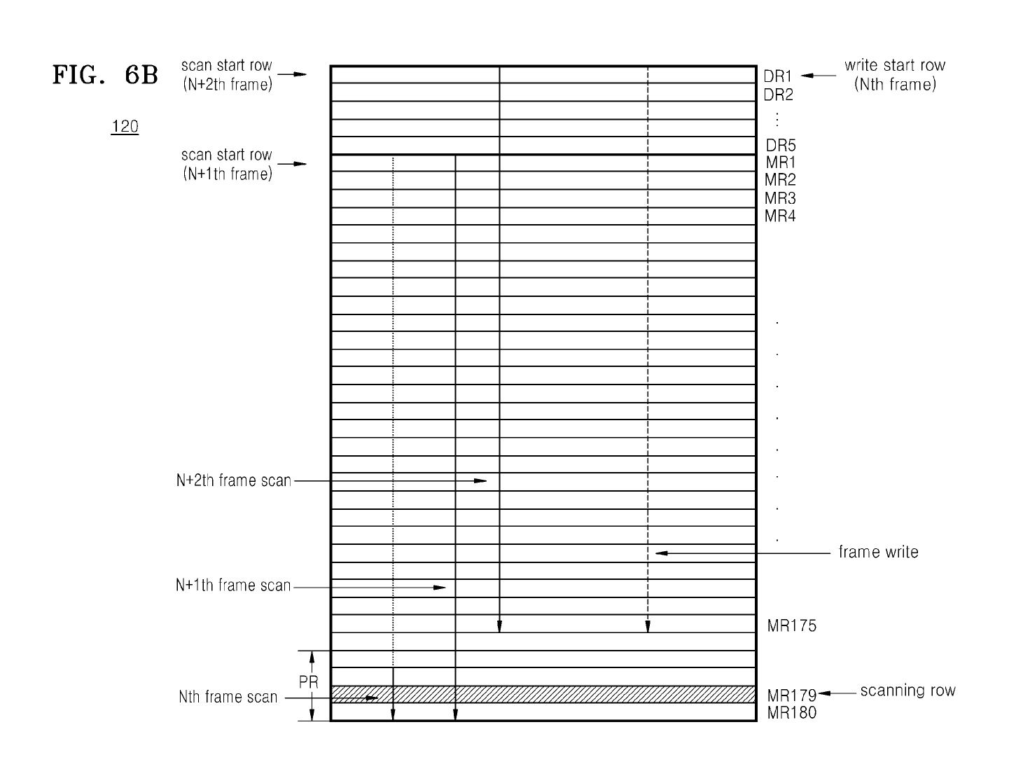

FIGS. 6A and 6B are a timing diagram and a frame memory diagram, respectively, for explaining another example of write and scan methods of frame memory 120. In particular, FIGS. 6A and 6B illustrate write and scan methods where a scan speed is faster than a write speed and a scanning row is one of predetermined rows PR including the final main row MR180.

Referring to FIGS. 6A and 6B, where the 179^{th} main row MR179 is scanned to display a lower horizontal line on panel 1100, for example, the 179^{th} horizontal line DL 179, in the N-th frame display period, frame data (hereinafter, referred to as first frame data) may be received from the external device and written to frame memory 120. In doing so, where a scan speed is faster than a write speed, scanning of frame memory 120 is performed earlier than writing of the first frame data in the (N+1)-th frame display period and thus a screen tearing effect may occur. Accordingly, to prevent generation of a screen tearing effect, where the first frame data is received from the external device while a predetermined lower main row PR including final main row MR180 in the N-th frame display period is scanned, first dummy row DR1 is selected as the scan start row and the first frame data is written to one hundred and eighty (180) rows consecutively from first dummy row DR1. Scanning starts from first main row MR1 in the (N+1)-th frame display period and thus the frame data before being updated to the first frame data, that is, the frame data displayed in the N-th frame display period, is displayed again. Then, in the (N+2)-th frame display period, scanning is performed by selecting the dummy row DR1 that was selected as the write start row, as the scan start row, and thus the frame data updated to the received first frame data is displayed.

The predetermined lower main rows including the final main row MR180 may be determined according to the scan speed, the write speed, and the length of a porch period. Where the write and scan operations are performed in the above method, the predetermined lower main rows may be determined in a range in which writing of a main row is not performed when displaying of the (N+1)-th frame starts.

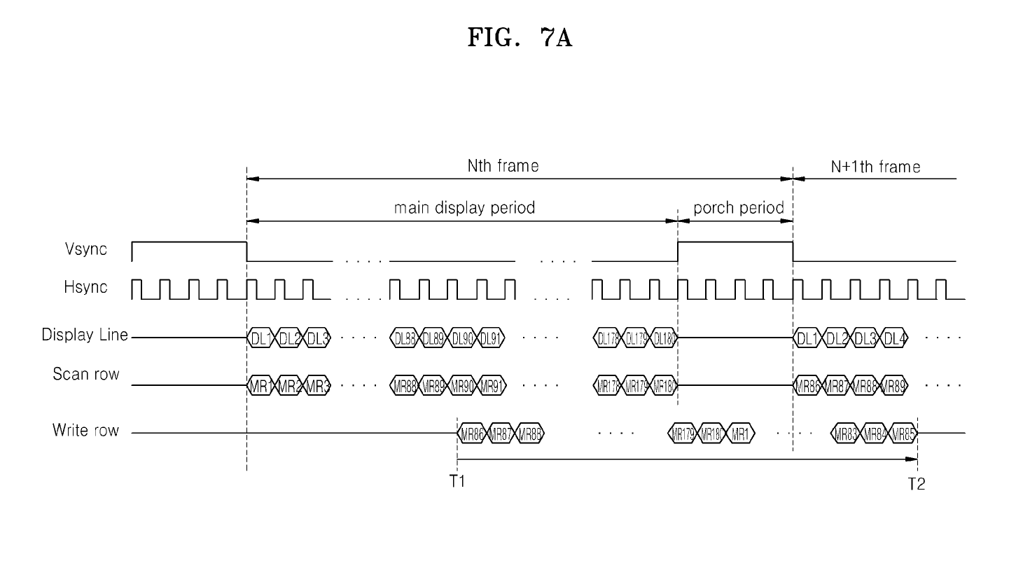

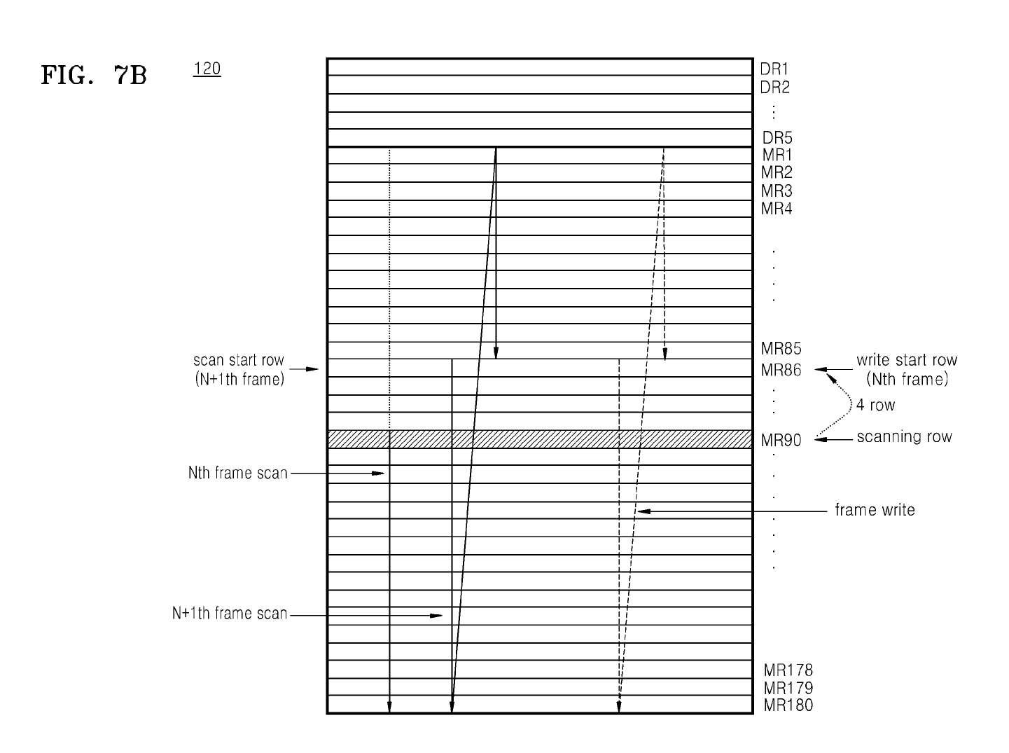

FIGS. 7A and 7B are a timing diagram and a frame memory diagram, respectively, for explaining another example of write and scan methods of frame memory 120. The method described with reference to FIGS. 7A and 7B is similar to the method described with reference to FIGS. 5A and 5B. However, in the method of FIGS. 5A and FIG. 5B, writing starts from a main row located a predetermined number of rows before the scanning row, and where the final main row is written, the writing continues from a dummy row. In the method of FIGS. 7A and 7B, however, after the final main row is written, the first main row, not the dummy row, may be continuously written. Accordingly, the received first frame data may be written to the entire M main rows. Also, like the write method, scan starts from a row where the writing started in the (N+1)-th frame display period, and where the final main row is written, the scan continues from the first main row.

Referring to FIGS. 7A and 7B, for example, where the first frame data is received from the external device at a time T1 where the 90^{th} main row MR90 is scanned in the N-th frame display period, writing may start from the 86^{th} main row MR86 that is located four (4) rows before the 90^{th} main row MR90. After the writing is continuously performed from the 86^{th} main row MR86 to the final main row MR180, the writing may continue from the first main row MR1 to the 85^{th} main row MR85. Where the (N+1)-th frame display period starts during writing, scanning starts from the 86^{th} main row MR86 and may continue until the 85^{th} main row MR85.

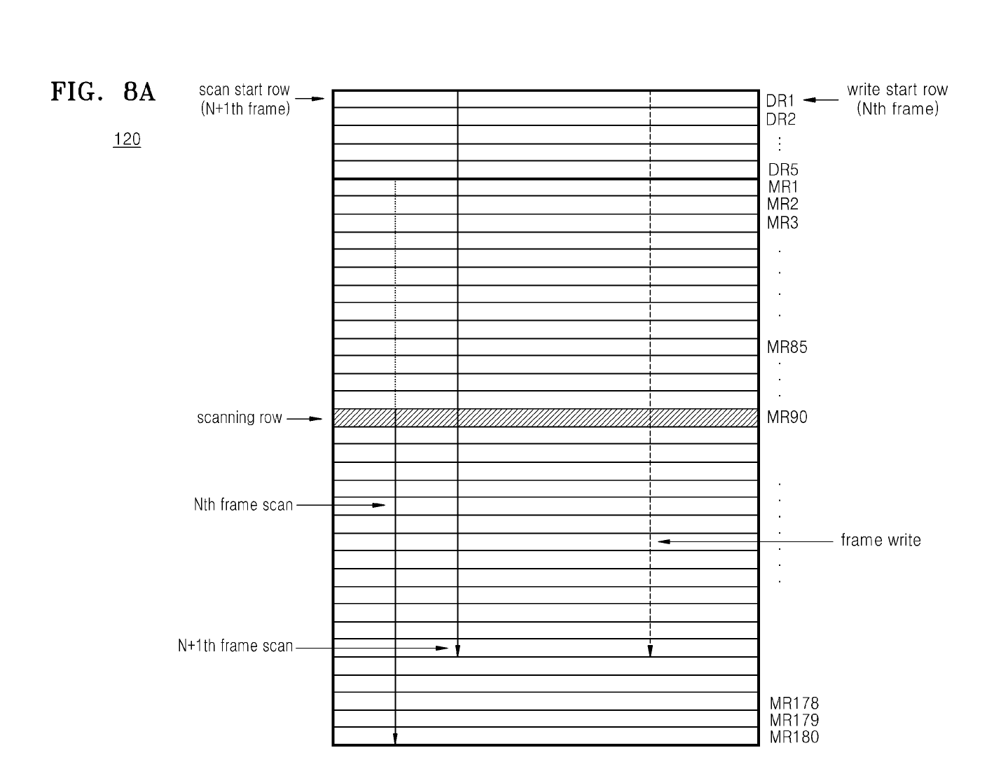

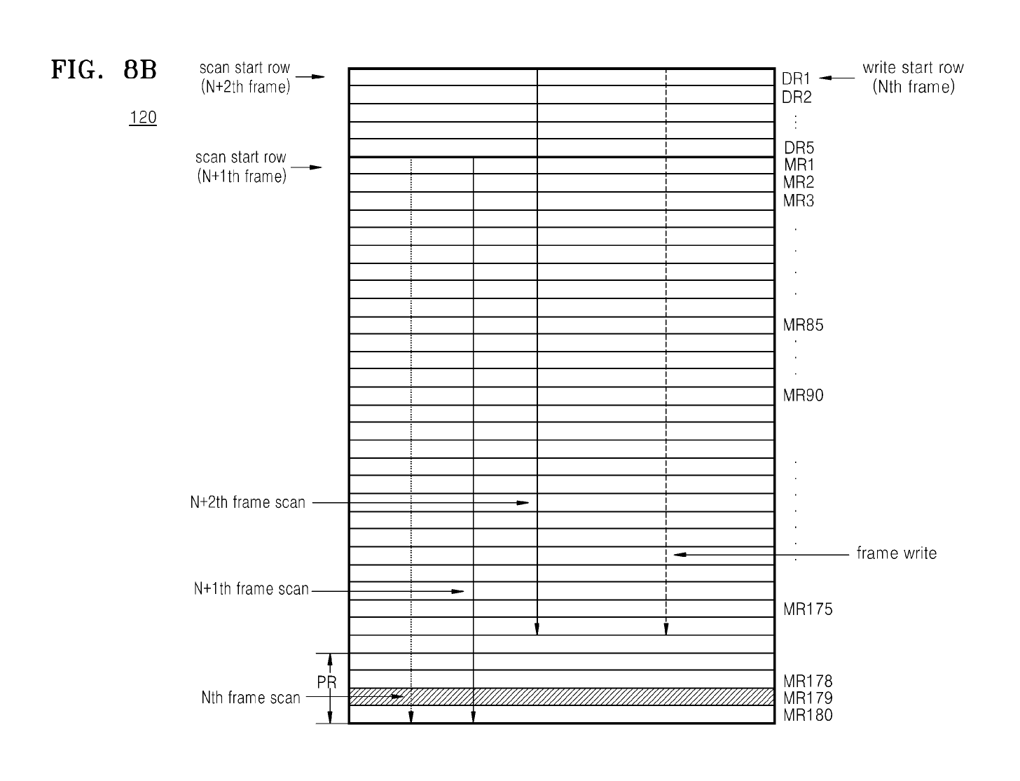

FIGS. 8A and 8B are a timing diagram and a frame memory diagram, respectively, for explaining another example of write and scan methods of frame memory 120.

Referring to FIG. 8A, where the first frame data is received from the external device in the N-th frame display period, first dummy row DR1 is selected as the scan start row and the scan start row of the (N+1)-th frame display period. The first frame data is written to and scanned from first dummy row DR1 without considering the scan speed, the write speed, and the scanning row.

Referring to FIG. 8B, if the scanning row is one of predetermined main rows including final main row MR180, first main row MR1, rather than first dummy row DR1 from which writing starts, may be selected as the scan start row of the (N+1)-th frame display period and thus the frame data before update may be displayed in the (N+1)-th frame display period. Also, first dummy row DR1 may be selected as the scan start row in the (N+2)-th frame display period and the rows where the first frame data is written are scanned, thereby displaying the first frame data in the (N+2)-th frame display period.

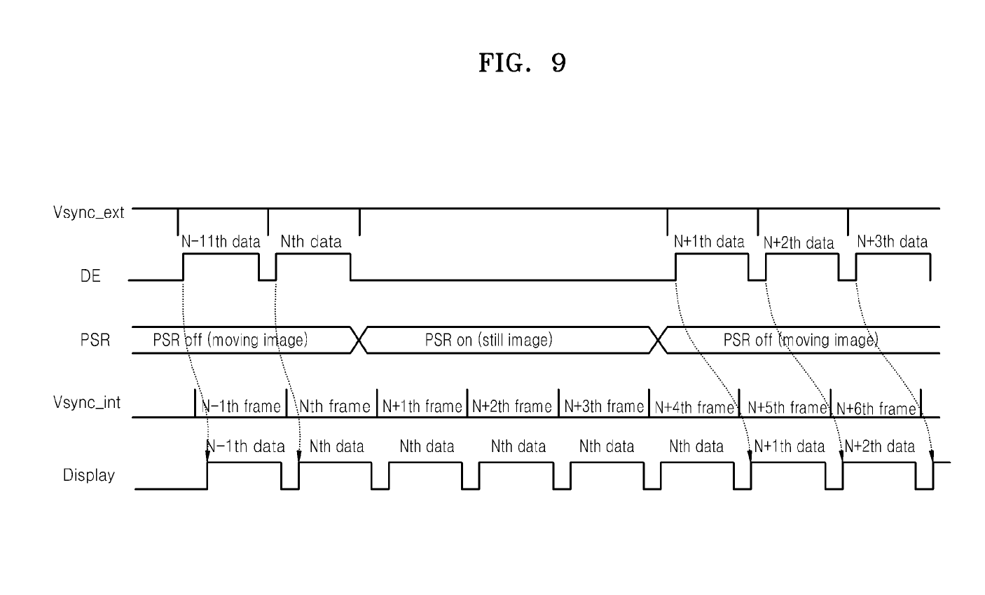

FIG. 9 is a timing diagram illustrating an example implementation of a panel self refresh (PSR) function in display device 1000 of FIG. 1. The PSR function transmits image data from a host to a display device only where an image to be displayed is a moving image, transmits image data of one frame to implement a still image to the display device where a moving image display mode is switched to a still image display mode, and stores the still image in the frame memory mounted in the display device, thereby displaying the stored image at every frame. In other words, because a host does not need to transmit image data and control signals to the display device where a still image is to be displayed, load on the host and consumption of current may be reduced.

Referring to FIG. 9, where a moving image is transmitted, a PSR function is turned off and the host transmits a vertical sync signal Vsync_ext, data enable signal DE, and a moving image to a display device. Where a still image is transmitted, the PSR function is turned on and the host does not transmit any signal.

Display device 1000 of FIG. 1 stores a transmitted image in frame memory 120 of FIG. 1 and displays the stored image on panel 1100 of FIG. 1. Where a valid image is transmitted regardless of whether a transmitted image is a moving image or a still image, the transmitted image is stored in frame memory 120. Whether the transmitted image is a valid image or not may be determined according to the transmitted data enable signal DE.

Display device 1000 of FIG. 1 generates an internal vertical sync signal Vsync_int by using reference clock RCLK generated therein and displays an image at every frame based on the image data output from frame memory 120 according to internal vertical sync signal Vsync_int. Internal vertical sync signal Vsync_int may be generated based on a vertical sync signal Vsync_ext transmitted from the host where the moving image is initially transmitted from the host. For example, a cycle of vertical sync signal Vsync_ext may be counted based on reference clock RCLK and then internal vertical sync signal Vsync_int may be generated to have the same cycle as the counted cycle.

For a display device operating in synchronization with the host, where the PSR function is turned on and then off, the host transmits a still image and then a moving image, a sync signal is transmitted to the host to prevent degradation in image quality or occurrence of a screen tearing effect. For example, the host transmits a signal indicating that a moving image is to be provided, to the display device and the display device receiving the signal transmits a sync signal indicating a point of time where an image is transmitted, to the host. The host may transmit image data after detecting the transmitted signal.

In contrast, in display device 1000 of FIG. 1, the host transmits a moving image to display device 1000 without transmitting a sync signal to the host. Accordingly, because the host does not need to detect the sync signal transmitted from display device 1000, a processing load of the host may be reduced. Thus, as display device 1000 operates according to the above-described frame memory scan and write method, an image may be displayed on panel 1100 without a screen tearing effect.

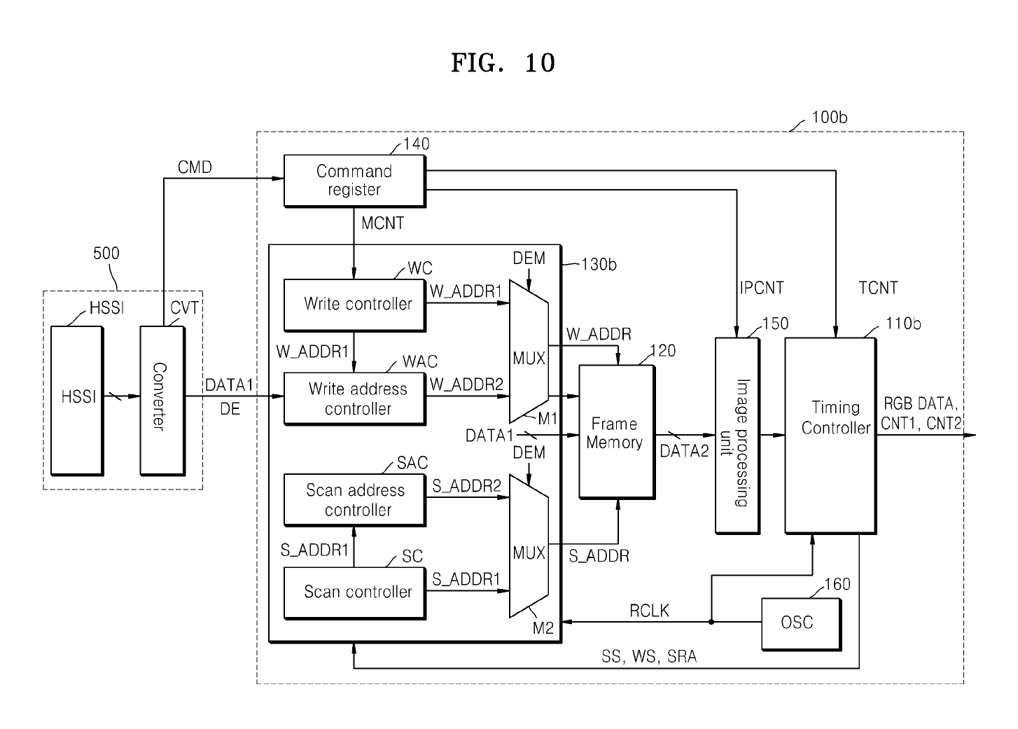

FIG. 10 is a block diagram illustrating another example of drive control unit 100 of FIG. 1. In the example of FIG. 10, operations of interface unit 500, command register 140, frame memory 120, image processing unit 150, and the oscillator 160 of a drive control unit 100b are substantially the same as those described with reference to FIG. 3, so a detailed description of these features will be omitted to avoid redundancy.

Referring to FIG. 10, a memory controller 130b comprises a write controller WC, a write address controller WAC, a scan controller SC, a scan address controller SAC, and two multiplexers MUXes M1 and M2.

The operations of write controller WC, write address controller WAC, scan controller SC, and scan address controller SAC are similar to the operations described with reference to FIG. 3. Write controller WC and scan controller SC respectively generate a first write address W_ADDR1 and a first scan address S_ADDR1 and provide the generated addresses to write address controller WAC and scan address controller SAC. Then, write address controller WAC and scan address controller SAC generate a second write address W_ADDR2 and a second scan address S_ADDR2 based on the write speed WS and the scan speed SS of the frame memory 120 and the scan row address SRA, provided by timing controller 110, respectively.

First multiplexer M1 selects one of first write address W_ADDR1 and second write address W_ADDR2 based on a data enable mode signal DEM and provides the selected address to frame memory 120 as a write address W_ADDR. Also, second multiplexer M2 selects one of first scan address S_ADDR1 and second scan address S_ADDR2 based on data enable mode signal DEM and provides the selected address to frame memory 120 as a scan address S_ADDR.

Where image data is non-periodically transmitted from the host, data enable mode signal DEM is activated, for example, to be a high level, and second write address W_ADDR2 and second scan address S_ADDRS are selected. Where image data is periodically transmitted from the host, data enable mode signal DEM is deactivated, for example, to be a low level, and may select first write address W_ADDR1 and the second scan address S_ADDRS.

Even where display driver circuit 1200 of FIG. 1 operates asynchronously with the host, if image data is periodically transmitted from the host, occurrence of a screen tearing effect may be prevented by adjusting a scan speed of frame memory 120 according to a write speed. Thus, the scan and write methods of frame memory 120 may be selected based on data enable mode signal DEM.

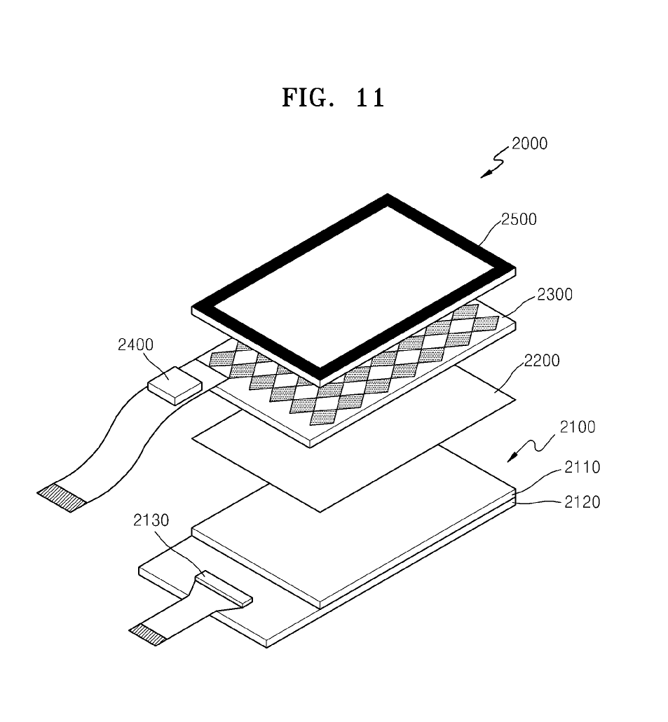

FIG. 11 is an exploded perspective view illustrating a display module 2000 according to an embodiment of the inventive concept.

Referring to FIG. 11, display module 2000 comprises a display device 2100, a polarized panel 2200, and window glass 2500. Display device 2100 comprises a display panel 2110, a printed board 2120, and a display driver chip 2130.

Window glass 2500 is generally manufactured of acryl or reinforced glass to protect display module 2000 from scratches due to external shocks or repeated touches. Polarized panel 2200 is provided to improve an optical feature of display device 2100. Display panel 2110 is formed on the printed board 2120 by being patterned as a transparent electrode. Display panel 2110 comprises a plurality of pixel cells to display a frame. According to an embodiment, display panel 2110 may be an OLED panel. Each pixel cell comprises an organic light emitting diode that emits light in response to flow of current. However, the inventive concept is not limited thereto and display device 2100 may include a variety of display devices. For example, display panel 2110 may be any one of an LCD, an ECD, a DMD, an AMD, a GLV, a PDP, an ELD, an LED display, and a VFD.

Display driver chip 2130 comprises the display driver circuit 1200 of FIG. 1. Although the display driver chip 2130 is illustrated as a single chip in the present embodiment, the inventive concept is not limited thereto and thus a plurality of driver chips may be mounted thereon. Also, the display driver chip 2130 may be mounted in a chip-on-glass (COG) form on the printed board 2120 of a glass material. However, this is a mere example and the display driver chip 2130 may be mounted in a variety of forms such as a chip-on-film (COF), a chip-on-board (COB), etc.

Display module 2000 further comprises a touch panel 2300 and a touch controller 2400. Touch panel 2300 is formed on a glass substrate or a polyethylene terephthalate (PET) film by being patterned as a transparent electrode such as indium tin oxide (ITO). Touch controller 2400 senses occurrence of a touch on touch panel 2300, calculates coordinates of a touch position, and transmits the touch coordinates to a host (not shown). Touch controller 2400 may be integrated in one semiconductor chip with the display driver chip 2130.

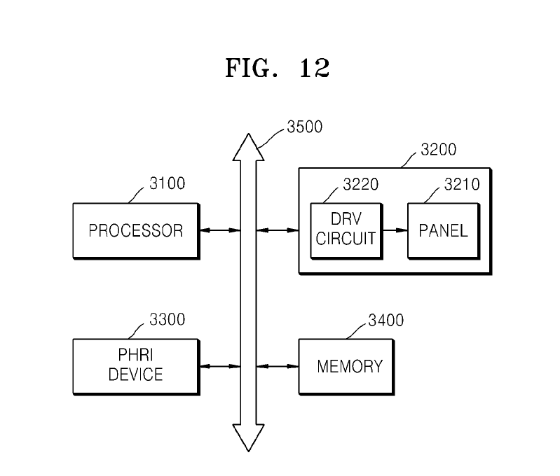

FIG. 12 is a block diagram illustrating a display system 3000 according to an embodiment of the inventive concept.

Referring to FIG. 12, display system 3000 comprises a processor 3100 electrically connected to a system bus 3500, a display device 3200, a peripheral device 3300, and a memory 3400.

Processor 3100 controls input/output of data among peripheral device 3300, memory 3400, and display device 3200 and performs image processing of image data transmitted between the above elements.

Display device 3200 comprises a panel 3210 and a driver circuit 3220 and stores image data received via the system bus 3500 in a frame memory of driver circuit 3220 and displays the stored image data on panel 3210. Display device 3200 may be display device 1000 of FIG. 1. Thus, display device 3200 operates asynchronously with processor 3100, which can reduce a processing load of processor 3100.

Peripheral device 3300 may a device such as a camera, a scanner, a webcam, etc. that converts a moving image or a still image to electrical signals. The image data acquired through peripheral device 3300 may be stored in memory 3400 or displayed on a panel (3210) of display device 3200 in real time.

Memory 3400 may comprise, for instance, a volatile memory device such as a DRAM and/or a non-volatile memory device such as a flash memory. Memory 3400 may also be a DRAM, a PRAM, an MRAM, a ReRAM, an FRAM, a NOR flash memory, a NAND flash memory, or a fusion flash memory in which, e.g., an SRAM buffer, a NAND flash memory, and a NOR interface logic unit are combined. Memory 3400 typically stores the image data acquired from peripheral device 3300 or an image signal processed by processor 3100.

Display system 3000 may be provided in a mobile electronic product such as a smart phone. However, the inventive concept is not limited thereto and display system 3000 may be applied to a variety of other electronic products capable of displaying an image.

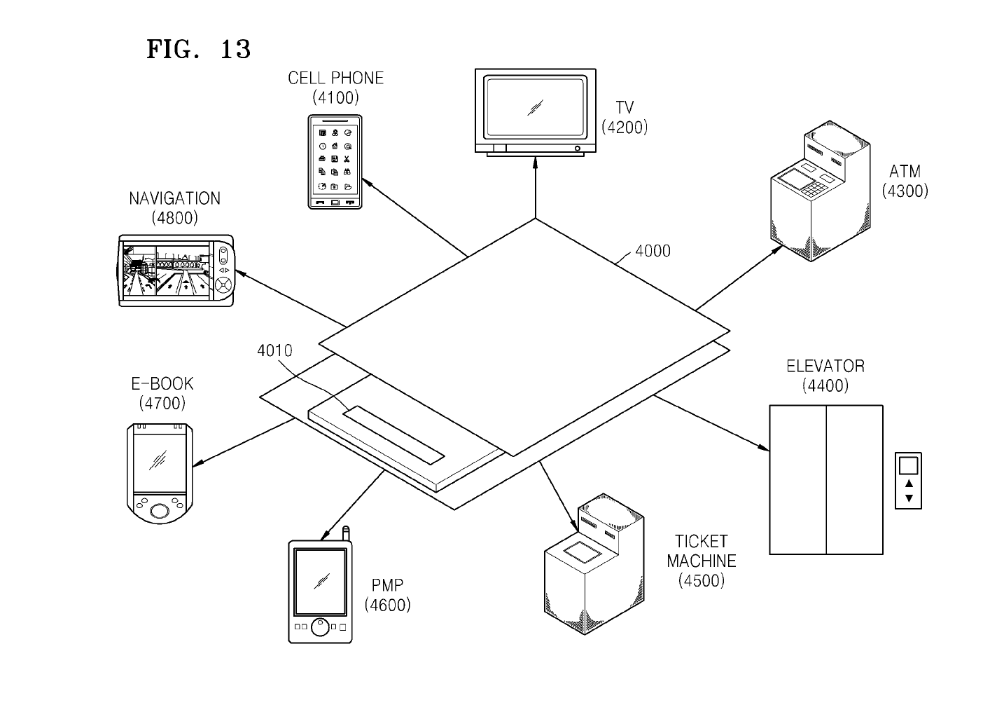

FIG. 13 illustrates various examples of electronic products having a display device according to an embodiment of the inventive concept. For example, the electronic devices of FIG. 13 may incorporate a display device such as those described above in relation to FIGS. 1 through 12.

Referring to FIG. 13, a display device 4000 may be applied to various electronic products, such as a cell phone 4100, a TV 4200, an ATM machine 4300, an elevator 4400, a ticket machine 4500, a PMP 4600, an e-book 4700, a navigation device 4800, etc. Display device 4000 may operate asynchronously with a processor of a system. Thus, because load on the processor is reduced and the processor can operate at high speed at low power, a function of an electronic product may be improved.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A display driver circuit comprising:
a frame memory comprising m main rows (m>1) and n dummy rows (0<n<m) corresponding to m horizontal display lines of a panel and configured to store received first frame data in m rows among the m main rows and the n dummy rows; and
a memory control unit configured to control write and scan operations of the frame memory such that the first frame data is written from a write start row selected from among the m main rows and the n dummy rows.

2. The display driver circuit of claim 1, wherein the memory control unit selects the write start row based on a write speed and a scan speed of the frame memory and a position of the main row that is scanned where the first frame data starts to be received from an external device.

3. The display driver circuit of claim 1, wherein the memory control unit selects a row located a predetermined number of rows before the main row that is scanned where the first frame data starts to be received, as the write start row, based on the write speed and the scan speed of the frame memory where the first frame data is received in an N-th frame display period.

4. The display driver circuit of claim 3, wherein, where the main row that is scanned is one of a predetermined set of main rows including an m-th main row, the memory control unit selects a first dummy row as the write start row, and selects a first main row as a scan start row of an (N+1)-th frame.

5. The display driver circuit of claim 1, wherein, where the first frame data is received in an N-th frame display period, the memory control unit selects a first dummy row as the write start row.

6. The display driver circuit of claim 5, wherein the memory control unit selects a first main row as a scan start row of a (N+1)-th frame where a main row that is scanned where the first frame data starts to be received is an m-th main row.

7. The display driver circuit of claim 1, wherein the memory control unit comprises:
a write address control unit configured to select the write start row and generate a write address to sequentially store the first frame data based on an address of the write start row; and
a scan address control unit configured to select a scan start row and generate a scan address to sequentially scan second frame data based on an address of the scan start row.

8. The display driver circuit of claim 1, further comprising a timing controller configured to transmit a control signal and second frame data scanned from the frame memory to a source driver, detect a write speed and a scan speed of the frame memory at every frame, and provide the memory control unit with the detected write speed and scan speed and a position of a main row that is currently being scanned.

9. The display driver circuit of claim 8, further comprising a clock generation unit configured to generate a reference clock signal, wherein the timing controller generates a horizontal sync signal and a vertical sync signal for display using the reference clock signal.

10. The display driver circuit of claim 8, wherein the timing controller controls the scan speed based on a write speed of the frame memory.

11. A display device comprising:
a panel comprising m (m>1) horizontal display lines; and
a driver circuit comprising a memory unit comprising k row addresses (k>m), and a memory control unit configured to select m write row addresses where a first frame data received from a host is to be written and m scan row addresses where a second frame data to be displayed on the panel is to be scanned, and to provide selected addresses to the memory unit.

12. The display device of claim 11, wherein the memory control unit is configured to sequentially select m row addresses of the k row addresses based on a write speed and a scan speed of the memory unit and a row address scanned where the received frame data starts to be written.

13. The display device of claim 12, wherein, after the m row addresses are scanned from the memory unit in a current display period, the memory control unit provides the selected m row addresses as the scan row address in a next display period.

14. The display device of claim 11, wherein the drive circuit drives the panel using a vertical sync signal and a horizontal sync signal that are internally generated.

15. The display driver of claim 11, wherein each pixel of the panel comprises an organic light emitting diode (OLED).

16. A method of operating a display driver circuit, comprising:
receiving a first frame of image data;
selecting a write start row from among m main rows (m>1) and n dummy rows (0<n<m) of a frame memory;
storing the first frame in m rows of the frame memory, beginning at the selected write start row; and
scanning the frame memory, starting at the write start row.

17. The method of claim 16, wherein the display driver circuit receives the first frame from a host and stores the first frame asynchronously with respect to the host.

18. The method of claim 16, further comprising selecting the write start row based on a write speed and a scan speed of the frame memory and a position of the main row that is scanned where the first frame data starts to be received from an external device.

19. The method of claim 16, further comprising selecting, as the write start row, a row located a predetermined number of rows before the main row that is scanned where the first frame data starts to be received, based on the write speed and the scan speed of the frame memory where the first frame data is received in an N-th frame display period.

20. The method of claim 19, wherein, where the main row that is scanned is one of a predetermined set of main rows including an m-th main row, the display driver circuit selects a first dummy row as the write start row, and selects a first main row as a scan start row of an (N+1)-th frame.
